(19) United States
(12) Patent Application Publication
(10) Pub. No.: US 2010/0059576 A1
(43) Pub. Date: Mar. 11, 2010

(54) TIN ALLOY SOLDER COMPOSITION

(75) Inventor: Karl F. Seelig, Jamestown, RI (US)

Correspondence Address: COOLEY GODWARD KRONISH LLP;ATTN: Patent Group, Suite 1100, 777 - 6th Street, NW, WASHINGTON, DC, 20001, US

(73) Assignee: American Iron & Metal Company, Inc., Montreal (CA)

(21) Appl. No.: 12/205,293

(22) Filed: Sep. 5, 2008

(51) Int. Cl. B23K 31/02; C22C 13/00; C22C 13/02; B23K 35/22

(52) U.S. Cl. 228/245; 420/560; 420/561; 148/23; 228/256

(57) ABSTRACT

A lead-free and solder alloy composition for electronic assembly applications having reduced toxicity. The alloy composition comprises, by weight, about 0.2% to about 1% copper; about 0.001% to about 0.039% nickel; about 0.001% to about 0.039% cobalt; and the balance of tin. The alloy composition has a melting temperature of about 227° C., with superior wetting and mechanical strength making the alloy composition wells suited for electronic circuit board manufacture and lead less component bumping or column arrays, and replacement of conventional tin-lead solders.

### TECHNICAL FIELD

The present invention relates generally to an improved solder composition. More specifically, the present invention relates to an improved solder composition that contains no lead yet still achieves superior soldering characteristics.

### BACKGROUND INFORMATION

Conventional solder alloys used in the manufacturing of printed circuit boards and assembly of electronic components generally contain tin and lead to provide mechanical and electrical connections. In plumbing applications, a higher proportion of lead is used to allow the alloy to solidify more slowly, so that it can be wiped over the joint to ensure a watertight seal. Traditionally, lead has been an important metal used for diluting tin to improve the solder's flow and wettability. Solders that contain tin and lead typically yield highly-reliable connections in both automated and manual soldering and provide a surface on printed circuit boards extremely conducive to soldering.

Tin-lead alloys of, for example, sixty (60%) percent tin, forty (40%) percent lead; and sixty-three (63%) percent tin, thirty-seven (37%) percent lead have historically been used for most electronic soldering operations. Those alloys have been selected and are preferred because of their low melting temperatures, mechanical strength, low relative cost, as well as superior wetting characteristics and electrical conductivity.

The use of such tin-lead solders in the manufacture of printed circuit boards and assembly of components is becoming more and more problematic due to the toxic effects of lead exposure to workers and the inevitable generation of hazardous waste. The detrimental health effects of exposure to even small amounts of lead have become more fully appreciated in recent years. For example, even small amounts of lead can affect the neurological development of fetuses in pregnant workers. Federal and many state government agencies have begun to urge the electronics industry to find alternatives to tin-lead solders to reduce worker lead exposure and lessen the amount of lead waste going back into the environment. Due to these adverse heath effects and overall impact on the environment, eliminating the use of lead, a toxic, heavy metal, is now an important consideration in working environments in which soldering operations are performed, operating environments in which soldered products are used, and the environment in general to which soldered products are disposed.

Due to the materials used, many components and printed circuit boards are easily damaged by exposure to high temperatures during manufacture or assembly. Because of heat transfer and distribution limitations and concerns, printed circuit boards are typically exposed to temperatures higher than the liquidus temperature of the alloy employed. In response to this concern, electronic manufacturers are exploring alternative alloys to replace the tin-lead alloys.

In order to provide a suitable lead-free solder substitute, the alloy must have flow and wettability characteristics similar to those of conventional tin-lead solders. Since tin has excellent wetting properties, it is an ideal metal to use as a base material in developing a lead-free solder alloy. Additional materials, including other metals, can then be added to this tin base to impart certain desirable characteristics of conventional tin-lead alloys, such as strength and flexibility, to the lead-free solder.

The prior art has not provided a solder composition exhibiting optimum wetting and flow properties without toxicity. Currently Federal, military and commercial solder specifications lack a suitable non-toxic composition. The following prior art patents illustrate inadequate attempts to meet these needs.

Soviet Union Patent No. 183,037, issued to A. I. Gubin et al. discloses an alloy containing antimony of 1±0.3%; copper 2±0.3%; silver 5±0.3% and the remainder being tin and having a melting point of 225°-250° C. That alloy has a liquidus temperature that does not allow it to be used in electronic soldering because the soldering temperature required to flow the alloy would destroy the printed circuit board and many of the components. No feasible equipment or means currently exists to allow this alloy to be used for the purpose of electronic soldering or coating. Due to the high silver content, this alloy has an economic disadvantage in the marketplace.

U.S. Pat. No. 3,503,721, issued to Lupfer, discloses a tin-silver alloy of 96.5% tin and 3.5±0.5% silver with wetting and electrical conductivity characteristics marginally acceptable to suit the needs of the electronics industry. However, that alloy has mechanical weaknesses that would prohibit its use on a wide range of electronic printed circuit board assemblies. For example, creep strength, a measure of flow under pressure, and percent elongation, metal stretching before fracture, are considerably lower than that of the tin-lead alloys now used. Even with the common tin-lead alloys, solder joints stress fractures are the cause of many field failures in printed circuit boards where vibration or temperature variations occur. In addition, the liquidus temperature of 221° C. requires that automated soldering be accomplished at a temperature that in many situations would damage the printed circuit board and/or the components. Due to the high content of silver, the cost of this alloy is considerably higher than tin-lead alloys.

U.S. Pat. No. 4,778,733, issued to Lubrano et al. discloses an alloy containing, by weight, 0.7% to 6% copper; 0.05% to 3% silver; with the remainder being tin with a temperature range of 440°-630° F. That alloy has a melting temperature that is too high to be used in a wide range of electronic soldering applications without damaging printed circuit boards or components. In addition, the alloy disclosed by Lubrano et al. exhibits inferior soldering performance, slow wetting times and mechanical strengths ill-suited to electronic assembly applications.

U.S. Pat. No. 4,695,428, issued to Ballentine et al. discloses an alloy containing 0.5-4% antimony; 0.5-4% zinc; 0.1-3% silver; 0.1-2% copper; 88-98.8% tin. The zinc content in this alloy causes the alloy to oxidize quickly. This inhibits wetting and flow, producing high dross formation which results in extremely high defect levels. The productivity lost in using such a composition for mass electronic soldering makes it an unacceptable alternative to tin-lead solders.

U.S. Pat. No. 4,758,407, issued to Ballentine et al. discloses an alloy containing tin, copper, nickel, silver and antimony. All of the alloy combinations disclosed by Ballentine et al. have liquidus temperatures in excess of those required for electronic assembly. The lowest disclosed liquidus temperature is 238° C., which is unacceptable for use in the electronics industry.

U.S. Pat. No. 6,180,055, issued to Tetsuro discloses an alloy containing, by weight, 0.1% to 2% copper; 0.002% to 1% Nickel; with the remainder being tin. The nickel content in this alloy inhibits wetting and causes slower initial wetting.

The most commonly used lead-free alloy is comprised of tin-silver-copper. Industry testing has proven that tin-silver-copper, lead-free solder alloys do not offer sufficient drop testing characteristics as compared to tin-lead solder alloys, especially on 0.3 mm Ball Grid Array (“BGA”) devices. Common tin-silver-copper alloys, known as SAC alloys, contain 3-4% silver and 0.5-1% copper. The main problem with those alloys in a BGA type application is the silver-tin intermetallic plate formation as well as Kirkendal voiding that occurs. To make SAC alloys more stable, several elements have been added to reduce copper erosion as well as limit large intermetallic plates from forming. For example, phosphorus (P), germanium (Ge), rare earth metals, antimony (Sb), nickel (Ni), and cobalt (Co) have been tried. In addition, the solder alloys composed of tin-silver-copper-antimony described in U.S. Pat. Nos. 5,352,407 and 5,405,577, issued to Seelig et al., each of which is incorporated by reference herein in its entirety, show improvement versus tin-silver-copper alloys, however there is still a need for enhanced performance.

Since no acceptable substitute for tin-lead alloys in BGA applications have been found, there remains a need in the electronics industry for an alloy composition without lead that can achieve the physical characteristics and application performance of tin-lead solder alloys but without the toxic elements.

### SUMMARY OF THE INVENTION

The present invention provides solder alloys with new advantages not found in currently available solder compositions, and overcomes many of the disadvantages of currently available compositions.

In one aspect, the invention is generally directed to novel and unique solder compositions with particular application in the electronic manufacturing of printed circuit boards and the assembly of components therein, as well as lead-less component bumping arrays and column arrays. The solder compositions of the present invention achieve desired physical characteristics, such as wetting, peel strength, low melting point, physical strength, fatigue resistance, electrical conductivity, matrix stability, and uniform joint strength, but without the toxic elements found in known tin-lead solder alloys.

The alloy compositions of the present invention comprise a combination of tin, copper, nickel, cobalt, and optionally silver, germanium, or antimony to offer a unique set of physical characteristics that provide a viable alternative to tin-lead alloys in electronic soldering and printed circuit board coating, as well as lead-less component bumping arrays and column arrays. The alloy of the present invention possesses physical characteristics that result in a stronger mechanical joint with superior fatigue resistance to tin-lead alloys, tin-silver alloys, or alloys containing bismuth.

In various embodiments of the present invention, the alloy has a reduced toxicity and a melting point of about 227° C. and includes, in weight percent, 98.2-99.8% tin; 0.2-1.0% copper; 0.001-0.039% nickel, and 0.001-0.039% cobalt. In alternative embodiments, the alloy further includes, in weight percent, 0.01-0.5% silver, 0.004-0.008% germanium, or up to about 0.2% antimony.

It is an object of the present invention to provide solder compositions that are a viable substitute for tin-lead solder alloys.

Another object of the present invention is to provide solder alloy compositions that are well suited for the electronic manufacturing of printed circuit boards and the assembly of components thereon.

It is a further object of the present invention to provide solder alloy compositions acceptable for the electronics industry that contain no lead.

It is yet a further object of the present invention to provide solder alloy compositions that are free of toxic elements and safe for the environment.

### DESCRIPTION

As indicated above, the present invention relates to lead-free solder compositions that contain tin, copper, nickel, and cobalt or contain tin, copper, nickel, cobalt, and silver, germanium, or antimony. Solder alloy compositions of the present invention have the physical characteristics and the application performance to economically meet the needs of the electronic industry and the assembly and coating of printed circuit boards. In particular, an alloy according to the invention exhibits ideal physical characteristics yet does not contain toxic elements as alloys found in the prior art which could harm workers and the environment.

Alloy compositions of the present invention that exhibit the desired physical characteristics are comprised by weight as follows:

| Metal | % Composition |
|---|---|
| Tin (Sn) | 98.2-99.8% |
| Copper (Cu) | 0.2-1.0% |
| Nickel (Ni) | 0.001-0.039% |
| Cobalt (Co) | 0.001-0.039% |
| Optionally Silver (Ag) | 0.01-0.5% |
| Optionally Germanium (Ge) | 0.004-0.008% |
| Optionally Antimony (Sb) | 0.0-0.2% |

In an embodiment, the solder composition comprises, by weight, about 0.2% to about 1% copper; about 0.001% to about 0.039% nickel; about 0.001% to about 0.039% cobalt; and the balance of tin. The melting temperature of the composition is about 227° C. The liquidus temperature of about 227° C. coupled with superior wetting allows the alloy of the present invention to be used with existing mass and hand soldering equipment without damaging most printed circuit boards or electronic components.

In another embodiment, the solder composition comprises, by weight, about 0.5% to about 0.7% copper; about 0.01% to about 0.03% nickel; about 0.01% to about 0.03% cobalt; and the balance of tin.

In another embodiment, the solder composition comprises, by weight, about 0.5% to about 0.7% copper; about 0.02% to about 0.03% nickel; about 0.02% to about 0.03% cobalt; and the balance of tin.

In alternative embodiments, the solder composition may further comprise, by weight, about 0.01% to about 0.5% silver; about 0.004% to about 0.008% germanium; or up to about 0.2% antimony, in addition to the tin, copper, nickel, and cobalt.

Not to be limited to any particular theory, it appears that nickel inhibits copper dissolution and also inhibits wetting. The same is true for cobalt. However, when nickel and cobalt are both present in the alloy, the resistance to copper dissolution is improved without as significant an effect on wetting. Thus, it appears that the presence of nickel and cobalt provide a synergistic effect on the alloy.

A copper dissolution study of tin-copper alloys was performed with and with out additives to find an alloy with good wetting characteristics and reduced copper dissolution. The Sn/Cu0.7 alloy was the base alloy of this study. This alloy was then doped with antimony, nickel, cobalt, and combinations thereof according to the following table.

| | |
|---|---|
| Alloy 0 | Sn/Cu0.7 |
| Alloy 1 | Sn/Cu0.7/Ni0.05 |
| Alloy 2 | Sn/Cu0.7/Co0.05 |
| Alloy 3 | Sn/Cu0.7/Sb0.2 |
| Alloy 4 | Sn/Cu0.07/Sb0.2/Ni0.05 |
| Alloy 5 | Sn/Cu0.7/Ni0.03/Co0.03 |

A 0.062 inch diameter copper wire was submerged in a molten alloy bath at 270° C. for 60 seconds. The wire was then removed, wiped and measured for dimensional change. The results of the testing are shown in the table below.

| Alloy | Diameter (inches) |
|---|---|
| Alloy 0 | 0.055 |
| Alloy 1 | 0.063 |
| Alloy 2 | 0.062 |
| Alloy 3 | 0.059 |
| Alloy 4 | 0.061 |
| Alloy 5 | 0.063 |

The test was repeated using the same wire samples and submersed for 120 seconds. The results of the testing are shown in the table below.

| Alloy | Diameter (inches) |
|---|---|
| Alloy 0 | 0.053 |
| Alloy 1 | 0.061 |
| Alloy 2 | 0.061 |
| Alloy 3 | 0.058 |
| Alloy 4 | 0.059 |
| Alloy 5 | 0.062 |

Finally, the test was repeated using the same wire samples and submersed for 180 seconds. The results of the testing are shown in the table below.

| Alloy | Diameter (inches) |
|---|---|
| Alloy 0 | 0.049 |
| Alloy 1 | 0.059 |
| Alloy 2 | 0.059 |
| Alloy 3 | 0.055 |
| Alloy 4 | 0.057 |
| Alloy 5 | 0.060 |

After several repeat experiments, it was determined that the copper dissolved at substantially the same rate into the each of the alloys. Alloy 0 had the had the highest dissolution rate at 21% dissolution of the wire into the solder bath. Alloy 3 had a 12% dissolution rate, Alloy 4 had a 8% dissolution rate, Alloy 1 and Alloy 2 had a 5% dissolution rate, and Alloy 5 had a 3.5% dissolution rate.

It was also observed that Alloy 3 wet the best and Alloy 0 was similar. Alloy 5 was the next best wetting followed by Alloy 4. Alloy 1 and Alloy 2 were the worst wetting of all of the alloys.

Based on this test, it appears that nickel and cobalt both inhibit copper dissolution and also inhibit wetting. However, there appears to be a synergistic effect when the two elements are combined because resistance to copper dissolution is improved while wetting is not as affected. Wetting time to zero cross section is used as a determining factor.

Additionally, it has been determined that reducing the nickel content to less than about 0.04% improves wetting (i.e., the capillary flow characteristics). The copper dissolution resistance of the alloy is also improved by adding cobalt with the nickel. An alloy composition with about 0.02% to about 0.03% by weight, of each nickel and cobalt shows a good balance for maximized wetting and minimized copper dissolution.

Optionally, additional metals can be added to the alloy composition. For example, adding about 0.008% to about 0.004% by weight germanium reduces grain size in the alloy. Germanium is an antioxidant, however, it is not stable for long periods of time. Also, the addition of up to about 0.2% by weight antimony helps stabilize the oxide reduction and seems to help reduce grain boundaries and oxide formation. It also gives the solder a longer pot life in a turbulent pot. Finally, the addition of about 0.01% to about 0.5% by weight silver seems to help capillary fill.

The alloys of the invention exhibit excellent wetting and melting temperatures, as well as superior physical strength, electrical conductivity, and thermocycling fatigue, for example. As a result of these excellent physical characteristics, solder alloy compositions of the present invention are successfully substituted for the known tin-lead alloys currently used for electronics assembly and printed circuit board manufacture, as well as lead less component bumping arrays and column arrays. Most capital equipment used in electronic soldering can employ these compositions. The low melting temperature is low enough not to cause heating damage to the board or components therein.

The alloy compositions of the present invention are well suited for many different applications. The alloys may be employed in the coating of circuit boards and printed circuit board manufacture by use of “hot-air leveling” or “roll-tinning”. These processes improve solderability on the circuit board. Also, the alloys may be used in the assembly of electronic components on printed circuit boards when using a wavesoldering machine. The alloys are also well suited for formation into various shapes and sizes, such as bars, ingots, wire, chips, ribbons, powder, preform and can be used with a core of flux. Therefore, the alloys of the present invention may be used for assembly of electronic components using solder wire and a heating device to hand solder the components to the board.

In the application of coating printed circuit boards, the compositions of the present invention have superior wetting characteristics and improved productivity. Tin-lead alloys of the prior art are easily contaminated by copper from the PC boards that are dipped into a bath during processing. Since compositions of the present invention contain copper, minor increases in the copper content do not readily affect performance of the compositions. In addition, these new compositions will not absorb copper as quickly as prior art tin-lead solders. As a result, these new alloys can remain functional much longer than prior art tin-lead alloys to reduce overall solder consumption drastically and reduce outlay by manufacturers. Moreover, the solderability of the coated board is extended because the intermetallics are distributed evenly throughout the grain boundary of the composition. The result is a higher quality printed circuit board that cannot be achieved by the use of prior art solder compositions.

In surface mount assembly or wavesoldering of components to printed circuit boards, the compositions of the present invention can employ the same hot temperatures, pre-heat temperatures, and process parameters as prior art tin-lead solders now currently in use. The nominal composition is very close to a eutectic alloy that exhibits physical characteristics important to high speed, low defect soldering. Since the solder alloys of the invention are less easily contaminated than tin-lead alloys, an increased usable life of the solder bath results. Further, solder joints formed by wavesoldering yield higher joint strengths and excellent electrical conductivity with even distribution of intermetallics throughout the solder joint.

The solder alloy compositions of the present invention may also be used in the assembly of electronic components using solder wire in a heating device to hand solder the components to the board. Such a method requires a composition that wets and spreads quickly at about 235° C. to about 260° C. Compositions of the present invention can be easily formed into a cored wire solder and used easily and successfully in hand soldering.

Overall, the alloy compositions of the present invention enjoy a combination of a sufficiently low melting temperature for electronic applications, superior wetting characteristics, and superior mechanical strength to make it an excellent alternative to tin-lead alloys for the needs of the electronic industry for manufacture of printed circuit boards and the assembly of components onto the boards. The superior solderability and wetting characteristics yield even pad thicknesses and low copper solubility to provide a tremendous advantage in the solder coating of printed circuit boards, such as by hot air leveling.

Other embodiments incorporating the concepts disclosed herein may be used without departing from the spirit and scope of the invention. The described embodiments are to be considered in all respects as only illustrative and not restrictive.

1. A lead-free solder alloy composition comprising by weight about 0.2% to about 1% copper; about 0.001% to about 0.039% nickel; about 0.001% to about 0.039% cobalt; and the balance of tin, the composition being substantially free from antimony.

2. The lead-free solder alloy according to claim 1, wherein the copper content by weight falls within the range of about 0.5% to about 0.7%; the nickel content by weight falls within the range of about 0.01% to about 0.03%; the cobalt content by weight falls within the range of about 0.01% to about 0.03%.

3. The lead-free solder alloy according to claim 1, wherein the copper content by weight falls within the range of about 0.5% to about 0.7%; the nickel content by weight falls within the range of about 0.02% to about 0.03%; the cobalt content by weight falls within the range of about 0.02% to about 0.03%.

4. The lead-free solder alloy according to claim 1, wherein the copper content by weight falls within the range of about 0.5% to about 0.7%; the nickel content by weight is about 0.02%; the cobalt content by weight is about 0.02%.

5. The lead-free solder alloy according to claim 1, further comprising by weight about 0.004% to about 0.008% germanium.

6. The lead-free solder alloy according to claim 1, further comprising by weight about 0.01% to about 0.5% silver.

7. (canceled)

8. The alloy composition of claim 1, wherein a flux core is inserted into the composition to form an electronic assembly flux cored wire solder.

9. The alloy composition of claim 1, wherein the composition constitutes a fluxed core of flux and the alloy particles.

10. The alloy composition of claim 1, wherein the alloy composition is formed into a solder bar.

11. The alloy composition of claim 1, wherein the alloy composition is formed into a solder ingot.

12. The alloy composition of claim 1, wherein the alloy composition is formed into a solder wire.

13. The alloy composition of claim 1, wherein the alloy composition is formed into a solder chip.

14. The alloy composition of claim 1, wherein the alloy composition is formed into a solder ribbon.

15. The alloy composition of claim 1, wherein the alloy composition is formed into a solder powder.

16. The alloy composition of claim 1, wherein the alloy composition is formed into a solder preform.

17. The alloy composition of claim 16, wherein the solder preform is fluxed.

18. The alloy composition of claim 16, wherein the solder preform is unfluxed.

19. The alloy composition of claim 1, wherein the alloy composition is employed in hot air leveling of printed circuit boards.

20. The alloy composition of claim 1, wherein the alloy composition is employed in assembling surface mounted printed circuit boards.

21. The alloy composition of claim 1, wherein the alloy composition is employed in the solder coating of printed circuit boards.

22. The alloy composition of claim 1, wherein the alloy composition is employed in roll tinning of circuit boards.

23. The alloy composition of claim 1, wherein the alloy composition is employed in surface mount assembly of electronic components onto a printed circuit board.

24. A lead-free solder alloy composition comprising by weight about 0.5% to about 0.7% copper; about 0.02% to about 0.03% nickel; about 0.02% to about 0.03% cobalt; and the balance of tin, the alloy composition being substantially free from antimony.

25. A lead-free solder alloy composition comprising by weight about 0.5% to about 0.7% copper; about 0.02% to about 0.03% nickel; about 0.02% to about 0.03% cobalt; about 0.01% to about 0.5% silver; and the balance of tin, the alloy composition being substantially free from antimony.

26. A lead less component bumping or column array comprising a lead-free solder alloy composition, the lead-free solder alloy composition comprising by weight about 0.2% to about 1% copper; about 0.001% to about 0.039% nickel; about 0.001% to about 0.039% cobalt; and the balance of tin, the alloy composition being substantially free from antimony.

27. An electronic assembly comprising a lead-free solder alloy composition, the lead-free solder alloy composition comprising by weight about 0.2% to about 1% copper; about 0.001% to about 0.039% nickel; about 0.001% to about 0.039% cobalt; and the balance of tin, the alloy composition being substantially free from antimony.

28. A method of forming a solder connection comprising:
applying a lead-free solder alloy composition, the lead-free solder alloy composition comprising by weight about 0.2% to about 1% copper; about 0.001% to about 0.039% nickel; about 0.001% to about 0.039% cobalt; and the balance of tin, the alloy composition being substantially free from antimony.

29. The method of claim 28 wherein the lead-free solder alloy is applied by hot-air leveling.

30. The method of claim 28 wherein the lead-free solder alloy is applied by roll-tinning.

31. The method of claim 28 wherein the lead-free solder alloy is applied by wavesoldering.

32. The method of claim 28 wherein the lead-free solder alloy is applied by hand soldering.
